(19) United States
(12) Patent Application Publication
(10) Pub. No.: US 2022/0013864 A1
(43) Pub. Date: Jan. 13, 2022

(54) METAL-AIR BATTERY

(71) Applicant: SHARP KABUSHIKI KAISHA, Sakai City (JP)

(72) Inventors: FUMITOSHI SUGINO, Sakai City (JP); SHINOBU TAKENAKA, Sakai City (JP); HIROTAKA MIZUHATA, Sakai City (JP)

(21) Appl. No.: 17/367,240

(22) Filed: Jul. 2, 2021

(30) Foreign Application Priority Data
Jul. 9, 2020 (JP) 2020-118609

(51) Int. Cl. H01M 50/463; H01M 12/08; H01M 50/411

(52) U.S. Cl. CPC H01M 50/463; H01M 50/411; H01M 12/08

(57) ABSTRACT

A metal-air battery includes a metal electrode, a positive electrode, an electrolyte, and an outer housing for housing them. A spacer is disposed between the metal electrode and the positive electrode. The spacer has a frame-shaped portion constituting an outer periphery, and an opening portion penetrating in a thickness direction. The frame-shaped portion has a communication portion that communicates with an outer edge of the frame-shaped portion and the opening portion, so that the electrolyte can flow inside and outside the frame-shaped portion, and the electrolyte can be preserved in the opening portion.

### BACKGROUND OF THE INVENTION

### Field of the Invention

The present invention relates to a metal-air battery having a spacer.

### Description of the Background Art

A metal-air battery converts an energy of a substance itself into a DC electric power by causing a reduction reaction on a positive electrode side and causing an oxidation reaction on a negative electrode side. For explaining this type of metal-air battery, a zinc-air battery will be taken as an example. The zinc-air battery is composed of an alkaline electrolytic solution, a zinc electrode (negative electrode) disposed in the electrolytic solution, and an air electrode (positive electrode) disposed between the electrolytic solution and an air flow path. In a zinc-air battery, an electric power is output from the zinc electrode and the air electrode as an electric discharge reaction proceeds.

For example, JP-T-2005-518644 discloses a metal-air cell having a separator on its surface and including an anode structure having an anode surrounded by a hard structure having a plurality of openings, a cathode, and a liquid electrolyte. Also, it is described that this separator is flexible and is made of a material such as polyolefin, and that the hard structure and a plastic-coated steel honeycomb structure mesh are used.

However, the conventional metal-air battery has had a configuration in which a negative electrode and a charging electrode or the negative electrode and an air electrode are tightly accommodated therebetween, and a free flowing space for an electrolytic solution is not provided. Thus, an amount of the electrolytic solution between the electrodes is small, and for example, only the electrolytic solution contained in the separator can be used for the reaction. For this reason, as the charge/discharge reaction is repeated, a water content in the battery is changed, the water content on the charging electrode side increases during charge, and the water content on the air electrode side decreases during discharge. As a result, there have been problems that an ion density in the electrolytic solution is remarkably changed, a charge/discharge efficiency is lowered, and cyclability is lowered.

The present invention has been made in view of the above conventional problems. An object of the present invention is to provide a metal-air battery capable of suppressing change in an ion density associated with the charge/discharge reaction to improve the charge/discharge efficiency and cyclability.

### SUMMARY OF THE INVENTION

In order to resolve the above problems, the present inventors have focused on a fact that the charge/discharge are based on a chemical reaction, and an electrolyte required for efficient charge/discharge cannot secured in a reaction field between a negative electrode and a positive electrode due to consumption of the electrolytic solution and ions in the electrolytic solution as reactants, and have found that the following configuration capable of securing a sufficient electrolyte in the reaction field is provided.

That means, on the presupposition that the metal-air battery includes a metal electrode, a positive electrode opposed to the metal electrode, an electrolyte, an outer housing for housing the metal electrode, the positive electrode, and the electrolyte, a solution of the present invention for achieving the above object is characterized in that a spacer for maintaining an interval between the metal electrode and the positive electrode is disposed between the metal electrode and the positive electrode, the spacer has a frame-shaped portion constituting an outer periphery, and an opening portion that penetrates in a thickness direction intersecting with the metal electrode and the positive electrode inside the frame-shaped portion, the electrolyte can be preserved in the opening portion, the frame-shaped portion has a communication portion that communicates with an outer edge of the frame-shaped portion and the opening portion, and the electrolyte can flow inside and outside the frame-shaped portion.

In addition, as for the metal-air battery including the above configuration, more specifically, it is preferable that the spacer has a rectangular outer shape including a bottom side portion disposed on a bottom portion side of the outer housing and a top side portion opposed to the bottom side portion, and the communication portion is disposed on at least the bottom side portion or the top side portion. In addition, it is preferable that the respective communication portions are disposed near both length-direction end portions of one side portion including the bottom side portion or the top side portion of the frame-shaped portion.

Also, as the metal-air battery having the above configuration, the positive electrode may include an air electrode and a charging electrode, and the spacer may be disposed between the metal electrode and the air electrode.

In this way, since the electrolytic solution can be secured in the reaction field by interposing the spacer between the negative electrode and the positive electrode, change in the ion density due to the reaction can be reduced, and the reaction efficiency can be improved.

The metal-air battery according to the present invention makes it possible to suppress change in the ion density associated with the charge/discharge reaction to improve the charge/discharge efficiency and the cyclability.

### BRIEF DESCRIPTION OF THE DRAWINGS

FIG. 1 is a schematic sectional view illustrating a metal-air battery according to Embodiment 1 of the present invention.

FIG. 2 is a perspective view illustrating a spacer in the metal-air battery.

FIG. 3 is an enlarged view of part B in FIG. 2.

FIG. 4 is an explanatory diagram illustrating an example in which one concave portion is provided in the spacer.

FIG. 5 is an explanatory diagram illustrating an example in which two concave portions are provided in the spacer.

FIG. 6 is an enlarged perspective view illustrating a spacer in a metal-air battery according to Embodiment 2 of the present invention.

FIG. 7 is a schematic sectional view illustrating a metal-air battery according to Embodiment 3 of the present invention.

FIG. 8 is a graph presenting results of charge/discharge measurement of a metal-air battery according to Example of the present invention.

FIG. 9 is a graph presenting results of charge/discharge measurement of a metal-air battery according to Comparative Example.

### DESCRIPTION OF THE PREFERRED EMBODIMENTS

Hereinafter, a metal-air battery according to embodiments of the present invention will be explained with reference to the figures.

### Embodiment 1

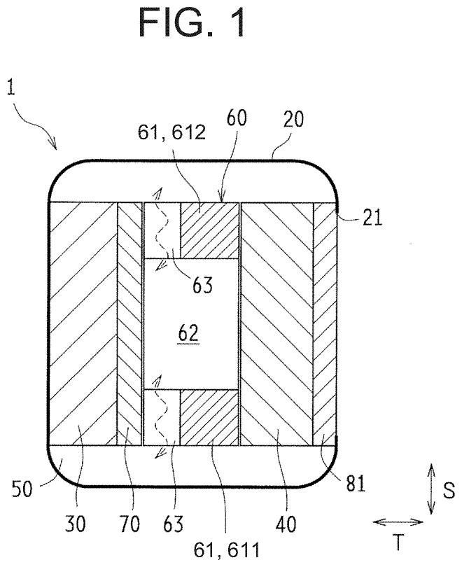

FIG. 1 is a schematic sectional view illustrating a metal-air battery 1 according to Embodiment 1. The metal-air battery 1 in FIG. 1 will be explained below in a manner that the up-down direction of the battery is represented by arrow S, and arrow T perpendicular to arrow S is assumed to be a thickness direction, for convenience of explanation. The up-down direction of the metal-air battery 1 is not limited to that direction, and the metal-air battery 1 can be handled in any direction.

The metal-air battery 1 includes an outer housing 20 that is an outer case, and a negative electrode (metal electrode) 30 and a positive electrode 40 are accommodated inside the outer housing 20.

The outer housing 20 serves as a container for accommodating the negative electrode 30 and the positive electrode 40 and also contains an electrolytic solution, which is sealed by welding. For example, preferably the outer housing 20 is a bottomed bag-shaped container that preserves an electrolytic solution 50, and is made of a material having corrosion resistance against the electrolytic solution 50. A shape of the outer housing 20 is not particularly limited as long as it can store the electrolytic solution 50, and examples of the shape include a rectangular shape, a cylindrical shape, and the like. Also, a volume of the outer housing 20 is not particularly limited. The outer housing 20 has an air inlet 21 and is provided with a water-repellent film 81.

For example, the outer housing 20 is preferably made of a thermoplastic resin material excellent in alkali resistance, e.g. a polyolefin-based resin film material (laminate film) such as polypropylene and polyethylene. In addition, the outer housing 20 is not limited to a single-layer structure composed of a single layer made of the resin film material, and may have a multi-layer structure in which a plurality of layers are laminated.

The negative electrode 30 is a metal electrode containing a metal as an electrode active material, constitutes a metal-air battery 1 together with the positive electrode 40, the outer housing 20, and the like, and takes out an electric energy obtained in a process that the metal changes into a metal oxide by an electrochemical reaction.

The metal constituting the negative electrode 30 is not particularly limited as long as it can be used as a negative electrode active material, and examples of the metal include a metal such as zinc, lithium, sodium, calcium, aluminum, magnesium, iron, copper, cobalt, cadmium, and palladium; an alloy containing two or more of these metals; and a mixture of these metals or alloys. When the metal-air battery 1 is composed of, above all, zinc, lithium, aluminum, or iron, the metal-air battery 1 can be actuated at room temperature. In addition, zinc, iron, aluminum, and copper are excellent in handleability. From the above viewpoint, as the negative electrode 30, a zinc electrode containing zinc as a main component is particularly preferably used.

A shape of the negative electrode 30 (anode) is not particularly limited, and examples of the shape include a flat plate shape, a rod shape, and the like. Above all, the flat plate-shaped negative electrode is preferably used. A thickness of the negative electrode 30 is not particularly limited, but is preferably 0.5 mm or more to 6 mm or less, more preferably 1 mm or more to 4 mm or less. If the thickness is less than 0.5 mm, there is a problem that a battery capacity is small, and if the thickness is more than 6 mm, there are problems that a layer of the negative electrode 30 is thicker and is difficult for the electrolytic solution to flow, and battery properties deteriorate.

The positive electrode 40 (cathode) is arranged so as to opposed to the negative electrode 30. Thereby, an interval between the electrodes can be uniformed and shortened, and a resistance between the electrodes can be suppressed. The positive electrode 40 includes an oxygen reducing catalyst having oxygen reducibility and/or an oxygen generating catalyst having oxygen generating ability, as constituent materials. Examples of a material of the oxygen reducing catalyst and/or oxygen generating catalyst include a conductive carbon such as Ketjen black, acetylene black, DENKA black, carbon nanotube, and fullerene, a metal such as platinum, iridium, and nickel, a metal oxide such as manganese oxide, a metal hydroxide, a metal sulfide, and the like. One or a plurality of these materials can be used.

As a preferable combination of the negative electrode 30 and the positive electrode 40 in the metal-air battery 1, zinc as the negative electrode active material and air as the positive electrode active material are combined. This combination makes it possible to achieve a chemical battery that has a low risk of spontaneous combustion and can be actuated at ordinary temperature.

The electrolytic solution 50 is preserved so as to fill the inside of the outer housing 20. In FIG. 1, the electrolytic solution 50 is illustrated without hatching for the purpose of facilitating understanding of the figure. The electrolytic solution 50 is a liquid containing an electrolyte and having ionic conductivity.

For example, the electrolytic solution 50 is a liquid having ionic conductivity, in which an electrolyte is dissolved in a solvent. The type of the electrolytic solution 50 is not particularly limited as long as it is an electrolytic solution used in a common chemical battery. The type may be selected depending on a type of a metal constituting the negative electrode 30, and may be an electrolytic solution using an aqueous solvent (electrolyte aqueous solution), or an electrolytic solution using an organic solvent (organic electrolytic solution).

As the combination of the negative electrode 30 and the electrolytic solution 50, for example when the negative electrode 30 contains zinc, aluminum, and iron as main components, an alkaline electrolytic solution such as a sodium hydroxide aqueous solution or a potassium hydroxide aqueous solution can be used as the electrolytic solution 50. When the negative electrode 30 contains magnesium as a main component, a neutral electrolytic solution such as a sodium chloride aqueous solution can be used as the electrolytic solution 50. When the negative electrode 30 contains lithium, sodium, and calcium as main components, an acidic electrolytic solution can be used as the electrolytic solution 50. When the negative electrode 30 contains lithium as a main component, it is preferable to use an organic electrolytic solution as the electrolytic solution 50.

The electrolytic solution 50 may contain a gelling agent so as to be gelled. The gelling agent is not particularly limited as long as the gelling agent is generally used for gelling an electrolytic solution in the field of chemical batteries. Examples of the gelling agent include a polyacrylate such as potassium polyacrylate and sodium polyacrylate, and the like.

As illustrated in FIG. 1, in the metal-air battery 1 according to Embodiment 1, a spacer 60 for maintaining an interval between the negative electrode 30 and the positive electrode 40 is disposed between the negative electrode 30 and the positive electrode 40. The spacer 60 is formed of a resin nonreactive with the electrolytic solution 50. In addition, the spacer 60 has a frame-shaped portion 61 constituting the outer periphery of the spacer 60, and an opening portion 62 penetrating in the thickness direction T intersecting with the negative electrode 30 and the positive electrode 40 inside the frame-shaped portion 61.

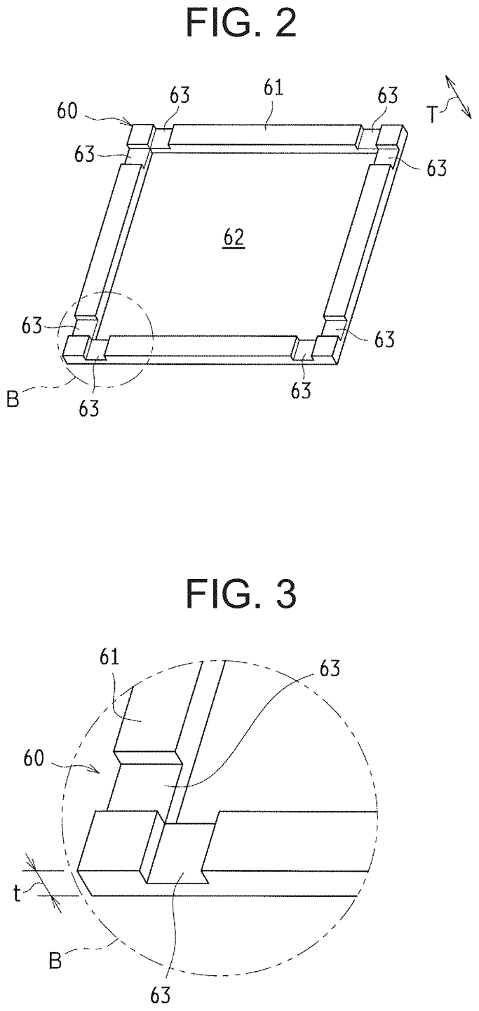

FIG. 2 is a perspective view illustrating the spacer 60, and FIG. 3 is an enlarged view of part B of the spacer 60 in FIG. 2. As illustrated in the figures, in Embodiment 1, the spacer 60 of the metal-air battery 1 has the frame-shaped portion 61 having a rectangular outer shape, and the opening portion 62 that opens and penetrates in the thickness direction T inside the frame-shaped portion 61.

The frame-shaped portion 61 is formed so as to have e.g. an outer shape equivalent to that of the negative electrode 30 and the positive electrode 40. One side of the frame-shaped portion 61 covers at least a part of the negative electrode 30, and the one side and the other side of the frame-shaped portion 61 cover at least a part of the positive electrode 40. Thereby, the negative electrode 30 and the positive electrode 40 are separated away from each other by at least the thickness t of the frame-shaped portion 61. The frame-shaped portion 61 has a concave portion 63 as a communication portion that communicates with the outer edge of the frame-shaped portion 61 and the opening portion 62, so that the electrolytic solution 50 can flow inside and outside the frame-shaped portion 61.

A shape of the opening portion 62 when the metal-air battery 1 is viewed from the side face direction (thickness direction T) is not particularly limited, and is preferably the rectangular shape as illustrated in FIG. 2. In addition to the rectangular shape, the opening portion 62 may have e.g. an oval shape, a square shape, a rectangular shape, a regular hexagonal shape, or the like.

When the opening portion 62 is circular or oval, a configuration in which gas (bubbles) is hard to stay on the opening portion 62 can be achieved. Such bubbles are e.g. result from air (mainly oxygen) that has entered from the outside (charging electrode or the like) during charging, air that has entered when inserting the negative electrode 30 into the outer housing 20, a gas (mainly hydrogen) generated by contact between the negative electrode 30 and the electrolytic solution 50, or the like. When the opening portion 62 has a polygonal shape such as a square shape or a rectangular shape, an opening ratio on the spacer 60 can be further increased.

As illustrated in FIG. 1, when the spacer 60 is disposed between the negative electrode 30 and the positive electrode 40, the electrolytic solution 50 can flow in the thickness direction T between the negative electrode 30 and the positive electrode 40, and the electrolytic solution 50 is preserved in the opening portion 62. In addition, the electrolytic solution 50 is preserved not only in the opening portion 62 inside the frame-shaped portion 61 but also in a region between the outside of the frame-shaped portion 61 and the outer housing 20. Since the spacer 60 includes the concave portion 63, the electrolytic solution 50 can flow reciprocally between the opening portion 62 inside the frame-shaped portion 61 and the outside of the frame-shaped portion 61. Thereby, the inside of the opening portion 62 that preserves the electrolytic solution 50 can be used as a reaction field between the negative electrode 30 and the positive electrode 40.

As illustrated in the enlarged view of FIG. 3, the concave portion 63 as the communication portion communicating with the outer edge of the frame-shaped portion 61 and the opening portion 62 is a groove-shaped portion obtained by removing not less than one-third of the thickness t of the frame-shaped portion 61. In this case, the thickness t of the frame-shaped portion 61 is equivalent to the thickness of the spacer 60, and the frame-shaped portion 61 is formed so as to have a thickness of 1 to 10 mm. A thickness t of less than 1 mm is undesirable because a sufficient amount of the electrolytic solution 50 cannot be secured in the reaction field between the negative electrode 30 and the positive electrode 40, and a discharge output is lowered. A thickness t of more than 10 mm is undesirable because an excessive amount of the electrolytic solution 50 is preserved between the negative electrode 30 and the positive electrode 40, a weight of the battery increases, and the energy density loss increases. The energy density loss refers to a value obtained by dividing a work capacity of the battery by the weight of the battery.

For example, when the thickness t of the frame-shaped portion 61 is 9 mm, the concave portion 63 is formed in a groove shape by removing the thickness of 3 mm. In the example illustrated in FIG. 2, the concave portion 63 is formed in a concave groove shape having a rectangular section. The concave portion 63 having less than one-third the thickness of the thickness t is undesirable because, when the frame-shaped portion 61 is disposed inside the outer housing 20, the groove shape of the concave portion 63 may be crushed, and it is difficult to exchange substances.

In the spacer 60, the concave portion 63 is provided on one side portion of the frame-shaped portion 61 extending in a horizontal direction perpendicular to an up-down direction S. For example, as illustrated in FIG. 2, the respective concave portions 63 are provided near both end portions of each side portion with respect to the rectangular frame-shaped portion 61. The respective concave portions 63 are provided on at least one set of side portions opposed to each other. In the spacer 60, the side portions including the concave portions 63 are disposed on the bottom portion side and the top portion side of the outer housing 20, so that the concave portions 63 are provided on at least a bottom side portion 611 and a top side portion 612, as illustrated in FIG. 1.

By providing the concave portion 63 in this way, the respective concave portions 63 are disposed on the frame-shaped portion 61 positioned on the bottom portion side and the frame-shaped portion 61 positioned on the top portion side as illustrated in FIG. 1, so that the electrolytic solution 50 can flow in the up-down direction S. Thus, in the outer housing 20, the electrolytic solution 50 can flow in the up-down direction S inside and outside the spacer 60 reciprocally, e.g. the electrolytic solution 50 flows from the lower concave portion 63 to the inside of the frame-shaped portion 61, or the electrolytic solution 50 inside the frame-shaped portion 61 flows from the upper concave portion 63. The lower concave portion 63 acts for smooth flow of the electrolytic solution 50 inside and outside the spacer 60, and the upper concave portion 63 effectively acts for discharging the gas in the spacer 60 when injecting the electrolytic solution 50 and for filling the opening portion 62 with the electrolytic solution 50.

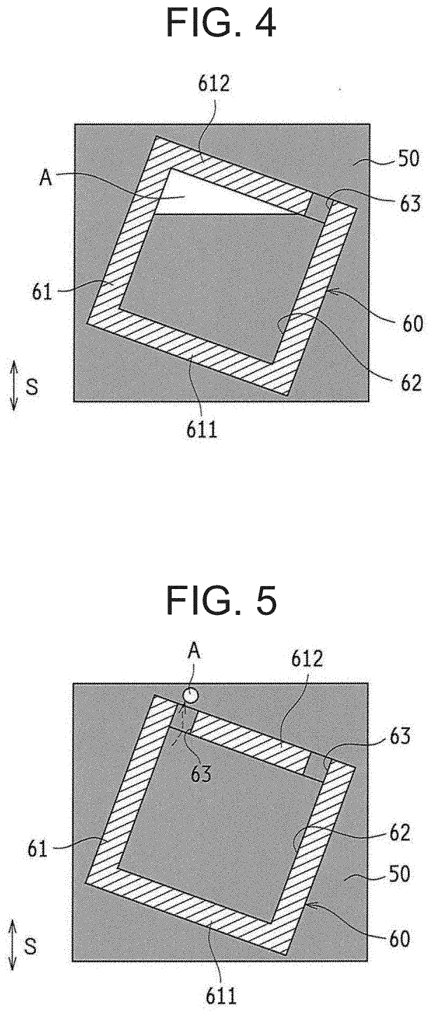

The respective concave portions 63 are provided near both length-direction end portions of one side portion of the frame-shaped portion 61, and it is preferable that the concave portions 63 are disposed on two positions of the one side portion. FIG. 4 illustrates an example in which one concave portion 63 is provided in the spacer 60, and FIG. 5 is an explanatory diagram illustrating an example in which two concave portions 63 are provided in the spacer 60 in comparison with FIG. 4. For these spacers 60, an example in which one or two concave portions 63 are provided on the top side portion 612 of the spacer 60 is illustrated.

As illustrated in FIG. 4, if the spacer 60 has a configuration in which one concave portion 63 is provided on one side portion (top side portion 612), bubbles (gas) A may stay inside the frame-shaped portion 61 depending on a degree of inclination of the outer housing 20 when the inside of the outer housing 20 is filled with the electrolytic solution 50. This is because, once one concave portion 63 is filled with the electrolytic solution 50, the bubbles A are not be discharged from the concave portion 63 to the outside of the spacer 60.

In contrast, as illustrated in FIG. 5, when the respective concave portions 63 are provided near the both end portions of one side portion of the spacer 60, even if one of the concave portions 63 is filled with the electrolytic solution 50 due to the inclination, the bubbles A can be discharged from the other concave portion 63. This makes it possible to fill the inside of the opening portion 62 of the spacer 60 with the electrolytic solution 50 to prevent the bubbles (gas) A from staying.

As illustrated in FIG. 1, the spacer 60 is provided such that the concave portion 63 is positioned on the negative electrode 30 side. Thereby, the groove shape of the concave portion 63 can be opened to the negative electrode 30 side. Thus, the electrolytic solution 50 present around the negative electrode 30 where the ion density changes can be convected at a place close to the electrolytic solution 50 present outside the frame-shaped portion 61, and it is possible to expect an effect of facilitating exchange of substances between the electrolytic solution 50 present inside the frame-shaped portion 61 as the reaction field and the electrolytic solution 50 present outside the frame-shaped portion 61.

Thus, as the most preferable configuration, it is preferable that, in the frame-shaped portion 61 of the spacer 60, each side portion has two concave portions 63, as illustrated in FIG. 2. Thereby, the spacer 60 can be oriented in any direction in the outer housing 20, and the plurality of effects resulting from the concave portion 63 can be securely obtained in the metal-air battery 1.

In the spacer 60, a ratio of the opening area of the opening portion 62 is preferably 80% to 100% of the surface area of one side of the negative electrode 30 opposed to the opening portion 62. If the ratio is lower than 80%, the area where the negative electrode 30 is covered with the spacer 60 is large, the area of the negative electrode 30 effective for the battery reaction is small, and a battery output may decrease. The ratio of higher than 100% is undesirable, because the size of the outer housing 20 is large, the total amount of the electrolytic solution 50 is also large, and the weight of the battery increases.

As illustrated in FIG. 1, the metal-air battery 1 further has a separator 70 between the negative electrode 30 and the spacer 60. In the exemplary embodiment, the separator 70 covers one side of the negative electrode 30 (side opposed to the positive electrode 40). The separator 70 only needs to cover at least a part of the negative electrode 30. The separator 70 has ion permeability.

As the separator 70, for example, a material through which hydroxide ions, metal ions, or the like can permeate can be used, and a material composed of a porous resin, an anion exchange membrane, a non-woven fabric, or the like can be used. Examples of the porous resin include polyethylene, polypropylene, nylon 6, nylon 66, polyolefin, polyvinyl acetate, polyvinyl alcohol-based materials, polytetrafluoroethylene (PTFE), and the like.

When a material that is difficult for metal ions to permeate is used as the separator 70, the metal ions desorbed from the negative electrode 30 can be prevented from diffusing into the electrolytic solution 50, and therefore the discharge efficiency can be improved. In addition, the charge/discharge efficiency can be improved by the separator 70. From the viewpoint of improving the flowing of the electrolytic solution 50, the separator 70 is preferably hydrophilized. In addition, the separator 70 preferably has electrolytic solution resistance (particularly, alkali resistance).

The metal-air battery 1 can secure a sufficient amount of the electrolytic solution 50 in the reaction field by disposing the spacer 60 having the above configuration between the negative electrode 30 and the positive electrode 40. The change in the ion density due to the reaction can be reduced and the reaction efficiency can be improved by increasing an absolute amount of the electrolytic solution 50 in the reaction field. This makes it possible to improve the discharge output of the metal-air battery 1 compared to the conventional configuration. In addition, the electrolytic solution 50 in the opening portion 62 as the reaction field and the electrolytic solution 50 outside the frame-shaped portion 61 that is not a reaction field and shows small change in the ion density can flow inside and outside the frame-shaped portion 61 of the spacer 60 by the concave portion 63, so that the change in the ion density can be reduced.

The concave portion 63 as the communication portion disposed on the spacer 60 is not limited to the groove-shaped portion having the rectangular section described above, and may have any shape as long as the concave portion 63 is a concave portion or a groove-shaped portion having a recess obtained by removing not less than one-third of the thickness t of the frame-shaped portion 61. In addition, the communication portion that communicates with the outer edge of the frame-shaped portion 61 and the opening portion 62 is not limited to the concave portion 63 having the above configuration, and may be e.g. a hollow aperture portion (through hole) that is formed so as to communicate with the opening portion 62 and a border portion outside the frame-shaped portion 61 and is arranged so as to penetrate the frame-shaped portion 61 in a direction intersecting with the thickness direction T.

### Embodiment 2

Since Embodiments 2 and 3 described below are common to Embodiment 1 in light of the basic configuration, configurations specific to each embodiment will be explained in detail, and the other configurations are described using the same reference numerals as in Embodiment 1, and explanation of the other configurations is omitted.

Embodiment 1 describes an example in which the concave groove-shaped concave portion 63 is provided on the spacer 60 of the metal-air battery 1. The concave portion 63 is not limited to the groove-shaped portion obtained by removing not less than one-third of the thickness t of the frame-shaped portion 61, and may be an aperture portion obtained by removing a part of the frame-shaped portion 61.

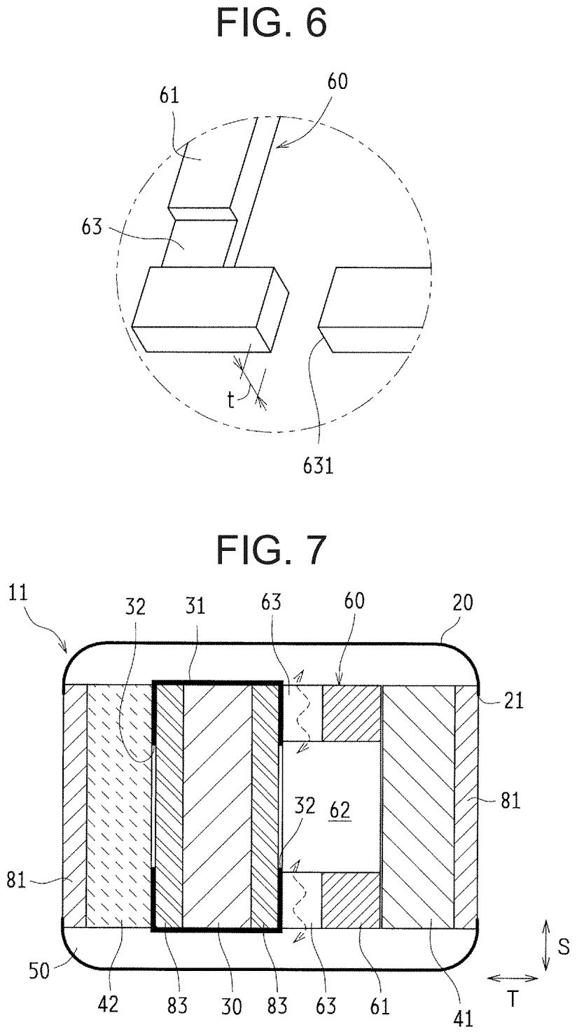

FIG. 6 is an enlarged perspective view illustrating another configuration example of the spacer 60 in the metal-air battery 1 according to Embodiment 2, and corresponds to the enlarged view of part B of the spacer 60 in FIG. 2. As illustrated in the figure, a concave portion 631 is formed by cutting off a part of the frame-shaped portion 61. That means, the concave portion 631 is formed by removing the whole of thickness t of the frame-shaped portion 61. The concave portion 631 is formed in a concave groove having a depth t in the thickness direction T.

In this case, the spacer 60 is composed of both such a concave portion 631 and the concave groove-shaped concave portion 63. The concave portion 631 is provided on any one side portion of the frame-shaped portion 61, so that the electrolytic solution 50 can more effectively flow. Note that the configurations of the metal-air battery 1 excluding the spacer 60 are common to Embodiment 1.

### Embodiment 3

Although the example including the negative electrode 30 and the positive electrode 40 as the metal-air battery 1 is described in Embodiment 1, the present invention is not limited to this example. The metal-air battery according to the present invention may be a metal-air battery 11 having an air electrode 41 and a charging electrode 42 as the positive electrode 40. FIG. 7 is a schematic sectional view illustrating the metal-air battery 11 according to Embodiment 3.

The spacer 60 is disposed between the negative electrode 30 and the air electrode 41. The spacer 60 itself can be the same as that described in Embodiment 1 or Embodiment 2. Although the spacer 60 is disposed between the negative electrode 30 and the air electrode 41 in FIG. 7, the spacer 60 may be disposed between the negative electrode 30 and the charging electrode 42.

The negative electrode 30 is housed in a resin negative electrode case (case) 31 and includes an anion film 83. The negative electrode case 31 includes openings 32 on the charging electrode 42 side and the spacer 60 side. The negative electrode case 31 is formed e.g. by folding and joining one or a plurality of sheet-shaped insulating film materials, or the like.

The anion film 83 allows anions to move between the positive electrode (air electrode 41 and charging electrode 42) and the negative electrode 30 while ensuring insulation property of the positive electrode and the negative electrode 30, to prevent short circuits due to formation of an electron conduction path between the electrodes. The anion film 83 is a film through which anions such as hydroxide ions involved in the battery reaction permeate, and contains organic substances and inorganic substances.

Zincate ions generated by the discharge reaction of the negative electrode 30 are diffused in the charging electrode in the battery, resulting in a short circuit failure of the battery. The anion film 83 has a hydroxide ion conductivity and allows the hydroxide ions to permeate. On the other hand, preferably the anion film 83 suppresses permeation of the zincate ions and inhibits diffusion of the zincate ions.

The air electrode 41 produces hydroxide ions from electrons, water, and oxygen. The air electrode 41 has a catalyst and becomes a positive electrode when the metal-air battery 11 discharges electricity. In the air electrode 41, use of an alkaline aqueous solution as the electrolytic solution 50 causes a discharge reaction in which water supplied from the electrolytic solution or the like, oxygen gas supplied from the atmosphere, and electrons react on the catalyst to generate hydroxide ions. In the air electrode 41, the discharge reaction proceeds at a three-phase interface where oxygen (gas phase), water (liquid phase), and an electron conductor (solid phase) coexist.

In addition, the air electrode 41 is provided such that oxygen gas contained in the atmosphere can diffuse and a part of the surface of the air electrode 41 is exposed to the atmosphere. In the configuration illustrated in FIG. 7, oxygen gas contained in the atmosphere is diffused in the air electrode 41 through the air inlet 21 of the outer housing 20.

The charging electrode 42 is a porous electrode that serves as a positive electrode for charging, and use of an alkaline aqueous solution as the electrolytic solution 50 causes a reaction in which oxygen, water, and electrons are generated from the hydroxide ions (charge reaction). That means, in the charging electrode 42, the discharge reaction proceeds on the three-phase interface where oxygen (gas phase), water (liquid phase), and the electron conductor (solid phase) coexist.

The charging electrode 42 is provided such that a gas such as oxygen gas generated by progress of the charge reaction can diffuse. For example, the charging electrode 42 is provided so as to communicate with outside air, from which a gas such as oxygen gas generated by the charge reaction is discharged.

Similar to the air electrode 41, the charging electrode 42 may also be provided with the water-repellent film 81. By providing the water-repellent film 81, leakage of the electrolytic solution 50 through the charging electrode 42 can be suppressed, and a gas such as oxygen gas generated by the charge reaction can be separated from the electrolytic solution 50 and discharged to the outside of the outer housing 20.

Also in the metal-air battery 11 configured in this way, a sufficient amount of the electrolytic solution 50 can be secured in the reaction field. The change in the ion density due to the reaction can be reduced and the reaction efficiency can be improved by increasing an absolute amount of the electrolytic solution 50 in the reaction field. This makes it possible to improve the discharge output of the metal-air battery 11 compared to the conventional configuration. In addition, the electrolytic solution 50 in the opening portion 62 as the reaction field and the electrolytic solution 50 outside the frame-shaped portion 61 that is not a reaction field and shows small change in the ion density can flow inside and outside the frame-shaped portion 61 of the spacer 60 by the concave portion 63, so that the change in the ion density can be reduced.

Also, the spacer 60 can be disposed between the negative electrode 30 and the charging electrode 42, and in that case, the opening portion 62 and the concave portion 63 can be used as a path for discharging oxygen gas generated in the charge reaction. Thereby, excessive voltage rise during the charge reaction can be suppressed.

As described above, the metal-air batteries 1 and 11 according to the present embodiments make it possible to secure a sufficient amount of electrolytic solution 50 in the reaction field between the negative electrode 30 and the positive electrode 40 (41, 42), to reduce change in the ion density due to the reaction, and to improve the reaction efficiency. This makes it possible to improve the discharge output of the metal-air batteries 1 and 11 compared to the conventional configuration. In addition, since the electrolytic solution 50 can flow inside and outside the reaction field by the concave portions 63 and 631 disposed on the spacer 60, change in the ion density can be reduced. Thereby, change in the ion density associated with the charge/discharge reaction can be suppressed to improve the charge/discharge efficiency and the cyclability.

### EXAMPLE

In Example of the metal-air battery according to the present invention, a zinc-air battery having the configuration of the metal-air battery 11 illustrated in FIG. 7 was prepared. In a negative electrode of the zinc-air battery, ZnO in an amount of 1.3 Ah was carried by a metal current collector. An alkaline aqueous solution was used as the electrolytic solution.

A water-repellent film had an area of 6×6 cm, a reaction surface of a charging electrode had an area of 5×5 cm, an anion film had an area of 7×5.25 cm, a reaction surface of the negative electrode had an area of 5×5 cm, and an opening of a negative electrode case had an area of 4.5×4.5 cm, and a reaction surface of an air electrode had an area of 5×5 cm. An outer housing was sealed by heat welding to prepare a metal-air battery.

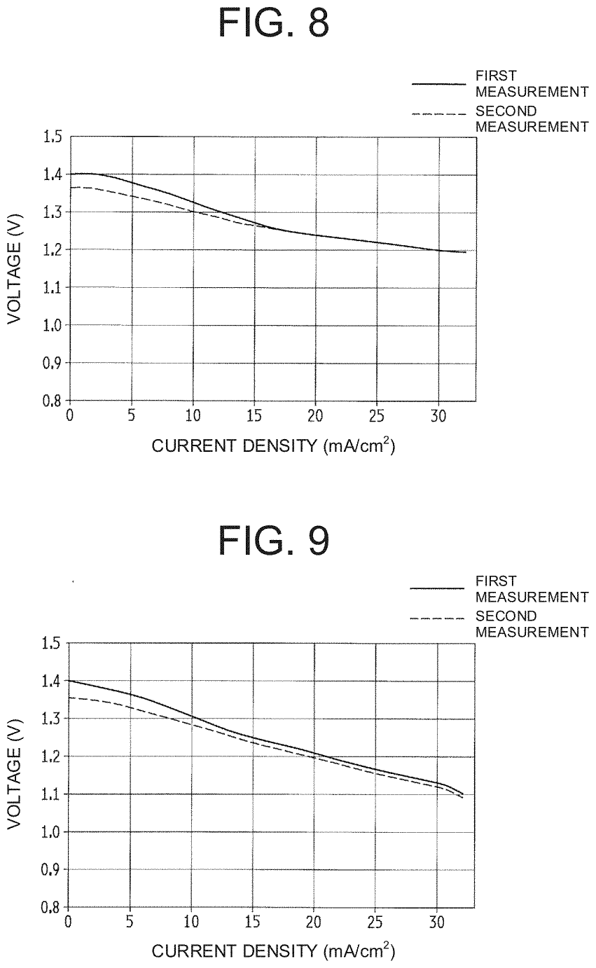

FIG. 8 and FIG. 9 are graphs presenting results of charge/discharge measurements of Example and corresponding Comparative Example. As contrasted with Example including a resin spacer (FIG. 8), Comparative Example including no spacer (FIG. 9) was prepared and subjected to the charge/discharge measurement.

For measurement conditions of the charge/discharge measurement, a depth was set to 60% at a current density of 10 mA/cm², and a charge/discharge cycle including a set of three charge/discharge operations was repeated multiple times. The current density during the discharge was set to 30 mA/cm². As illustrated in FIG. 8, when the metal-air battery includes a spacer and an electrolytic solution was secured in a reaction field on a discharge side, a voltage at 30 mA/cm² was 1.20 V, whereas, in Comparative Example having no spacer illustrated in FIG. 9, a voltage at 30 mA/cm² was 1.12 V. It was confirmed that the voltage at 30 mA/cm² was improved by 0.08 V by providing the spacer to the metal-air battery.

In addition, in Comparative Example, the charge/discharge cycle could be repeated only 3 times (3 cycles), whereas in Example, the charge/discharge cycle could be repeated 30 times (30 cycles) or more. Particularly, in Comparative Example, a coulombic efficiency was low from the beginning of the measurement, and the discharge could not be sufficiently performed, whereas in Example, a high coulombic efficiency could be maintained up to 36 cycles. This is because, in Example, the amount of the electrolytic solution could be sufficiently secured by the spacer, and therefore change in the ion density could be suppressed. It was confirmed that the metal-air battery according to Example made it possible to suppress change in the ion density associated with the charge/discharge reaction to improve the charge/discharge efficiency and the cyclability.

The present invention is not limited to each of the aforementioned embodiments, and various modifications can be made thereto within the scope indicated by claims. An embodiment that can be implemented by appropriately combining technical means disclosed in the different embodiments also falls within the technical scope of the present invention.

What is claimed is:

1. A metal-air battery comprising
a metal electrode,
a positive electrode opposed to the metal electrode,
an electrolyte, an outer housing that houses the metal electrode, the positive electrode, and the electrolyte, wherein
a spacer that maintains an interval between the metal electrode and the positive electrode is disposed between the metal electrode and the positive electrode,
the spacer has a frame-shaped portion constituting an outer periphery, and an opening portion that penetrates in a thickness direction intersecting with the metal electrode and the positive electrode inside the frame-shaped portion, and the electrolyte can be preserved in the opening portion, and
the frame-shaped portion has a communication portion that communicates with an outer edge of the frame-shaped portion and the opening portion, and the electrolyte can flow inside and outside the frame-shaped portion.

2. The metal-air battery according to claim 1, wherein a separator that covers at least a part of the metal electrode is disposed between the metal electrode and the spacer in the outer housing.

3. The metal-air battery according to claim 1, wherein
the spacer is made of a resin nonreactive with the electrolyte.

4. The metal-air battery according to claim 1, wherein
the spacer has a rectangular outer shape comprising a bottom side portion disposed on a bottom portion side of the outer housing and a top side portion opposed to the bottom side portion, and
the communication portion is disposed on at least the bottom side portion or the top side portion.

5. The metal-air battery according to claim 4, wherein
the respective communication portions are disposed near both length-direction end portions of one side portion comprising the bottom side portion or the top side portion of the frame-shaped portion.

6. In the metal-air battery according to claim 1, wherein
the communication portion is a concave portion, a groove-shaped portion, or an aperture portion, obtained by removing not less than one-third of a thickness of the frame-shaped portion.

7. The metal-air battery according to claim 1, wherein
the spacer is provided such that the communication portion is positioned on the metal electrode side.

8. The metal-air battery according to claim 1, wherein
the positive electrode comprises an air electrode and a charging electrode, and the spacer is disposed between the metal electrode and the air electrode.

9. The metal-air battery according to claim 1, wherein
a ratio of an opening area of the opening portion is 80% to 100% of a surface area of one side of the metal electrode opposed to the opening portion.
